(19) United States
(12) Patent Application Publication
(10) Pub. No.: US 2025/0178212 A1
(43) Pub. Date: Jun. 5, 2025

(54) INTEGRATED AUTOMATIC TOOL CHANGER DEVICE, SYSTEM, AND METHOD FOR ROBOTIC INTERACTION WITH A WORKPIECE

(71) Applicant: Thomas E. Gross, JR., Oxford, MI (US)

(72) Inventor: Thomas E. Gross, JR., Oxford, MI (US)

(21) Appl. No.: 18/965,136

(22) Filed: Dec. 2, 2024

Related U.S. Application Data
(60) Provisional application No. 63/604,975, filed on Dec. 1, 2023.

(51) Int. Cl. B25J 15/00; B25J 9/16; B25J 19/00

(52) U.S. Cl. CPC B25J 15/0057; B25J 9/161; B25J 19/0025

(57) ABSTRACT

A tool changer device for a robot includes a motor and a turret rotatably coupled to the motor. The turret may be capable of rotating about a turret axis and may be equipped with a tool. The device also includes a controller that may be in communication with the motor, the tool, and the robot. The controller may be configured to operate the motor to selectively move one of the tools arranged on the turret to an active position by rotating the turret. The controller may also selectively hold the active tool at the active position for independent interaction with a workpiece. The controller may selectively move the active tool to an inactive position and another tool on the turret to the active position by rotating the turret. The controller may be further capable of selectively holding the other tool in the active position for independent interaction with the workpiece.

### CROSS-REFERENCE TO RELATED APPLICATIONS

This application claims the benefit of U.S. Provisional Application No. 63/604,975, filed on Dec. 1, 2023. The entire disclosure of the above application is incorporated herein by reference.

### FIELD

The present technology relates to a tool changing device for use with robots, robots equipped with a tool changing device, and systems and methods for operating tools of a tool changing device to interact with robots and workpieces.

### INTRODUCTION

This section provides background information related to the present disclosure which is not necessarily prior art.

Tool changers may be used in robotic systems to enable a robot to switch between different tools or end effectors for performing various tasks. Operation of certain tool changers may involve manual intervention or require complex mechanical systems to achieve tool switching, swapping, or replacement, each of which may be time-consuming and inefficient. These approaches often involve the use of additional actuators, linkages, and mechanisms to facilitate the tool changing process and may require participation by a human operator.

Certain approaches to tool changing involve the use of a manual tool changer, where an operator manually removes and replaces the tools and/or the entire end effector on a robot. This approach requires human intervention and may be labor-intensive, especially in situations where frequent tool changes are required. Additionally, manual tool changers may not be suitable for applications where high degrees of precision and repeatability may be needed, or where the work environment is not suitable for a human operator.

Other approaches to tool changing involve the use of mechanical tool changers, which utilize complex mechanical systems to facilitate the swapping of tools. These mechanical tool changers may involve the use of additional actuators, linkages, and locking mechanisms to secure the tools in place. While mechanical tool changers may provide a more automated solution compared to manual tool changers, they may be bulky, expensive, and limited in the type and/or number of tools that may be employed on a robot or an end effector.

Additional approaches to tool changing may involve the use of magnetic tool changers, where magnets (e.g., electromagnets) may be used to index and/or secure a tool in place. Magnetic tool changers may provide a quick and efficient tool changing process, as they eliminate the need for complex mechanical systems. However, magnetic tool changers may have limitations in terms of the number, weight, and/or size of the tools that may be accommodated.

With respect to robotic milling of a workpiece, as an example of an operation that may involve many different types of tools, various other approaches are also known. Certain solutions may include a spindle tool mounted to a machine spindle. In such cases, to change a tool the robot must move to a tool holder stand, unclamp the tool into the stationary tool holder, release the tool, move to the desired tool, clamp the tool, and then reposition back to the workpiece. The tool change cycle time may be several minutes per tool change. This undesirably results in additional manufacturing cycle time and greater costs.

Alternatives for robotic milling with a spindle tool may include laser beam machining. However, laser machining may be slow and costly. Laser beam machines may also be limited in the materials and/or geometries that are effectively workable or accessible to the laser and thereby may not be suitable for certain operations intended to mimic mechanical drilling, reaming, boring, or tapping operations.

One automatic tool changer device is described in International PCT Publication No. WO2016059095, titled “Tool Changing Device For Manipulators,” to Zunke et al., and assigned to KUKA Systems GmbH. The Zunke publication relates to a tool changing device for industrial robots or lightweight robots, having a housing for attaching to a manipulator hand. The tool changing device of Zunke has a tool turret having a turret carrier mounted rotatably on the housing, and two or more tools are arranged on the turret carrier. The Zunke turret carrier is rotatable about a turret axis extending in an inclined manner with respect to the drive shaft, in order to move in each case one tool alternately into an active position.

The tool changing device of Zunke, however, has a latching device which keeps a tool in a latched position, in particular in an active position. Although designed to provide a limited retaining force, it is not always convenient or necessary to guide the tool changing device to an external object or position just to overcome the limited retainer force and move the tool from the active position. This is believed to undesirably result in additional time required per tool change, and likewise higher manufacturing cycle time and greater costs.

Accordingly, there is a continuing need for a tool changing device, system, and method that reduce cycle times for robotic milling operations due to a fast integrated automatic tool changing capability in a robotic manufacturing operation. Desirably, the tool changing device, system, and method also minimize a need for a cutting tool storage stand in the robotic manufacturing operation.

### SUMMARY

In concordance with the instant disclosure, a tool changing device, system, and method that reduces cycle times for robotic milling operations due to a fast integrated automatic tool changing capability in a robotic manufacturing operation, and which also minimizes a need for a cutting tool storage stand in the robotic manufacturing operation, has surprisingly been discovered. The present technology includes articles of manufacture, systems, and processes that relate to robot tool changer devices with turret rotation and tool selection capabilities.

In certain embodiments, a tool changer device for a robot may include a turret, a motor, and a controller. The turret may be rotatable relative to the robot about a turret axis. The turret may include a plurality of tool positions. The motor may be configured to rotate the turret. The controller may be configured to be in communication with the turret, the plurality of tool positions, the motor, and the robot. The controller may selectively move one of tool positions to an active position by rotating the turret.

In certain embodiments, a method for integrated automatic tool changing in a robotic system may include providing a turret rotatable about a turret axis. A plurality of tools may be arranged on the turret. One of the plurality of tools may be moved to an active position by rotating the turret. The first tool at may be held at an active position configured to interact with a workpiece.

In certain embodiments, the tool changer device for a robot may include a motor, a turret rotatably coupled to the motor and configured to hold a plurality of tools, and a controller facilitating their operation. This controller may selectively move a tool to an active position, allow independent interaction with a workpiece, and transition between an active and inactive tool by rotating the turret.

In certain embodiments, the tool changer device may include a disk-type tool changer for a robot, featuring a fixed base, a motor with a drive shaft, and a turret with multiple tools. The controller here enables selective tool positioning for independent workpiece interaction and transitioning between tools on the turret while facilitating the robot's movements. An automatic tool changer may be integrated into the robot and a motor-driven turret with various tools and a controller orchestrating tool movements, enabling independent workpiece interaction while managing tool transitions effectively.

In certain embodiments, the tool changer device may include a crown-type tool changer may integrate a belt drive unit, a motor, a rotatable turret, and multiple tools. The controller may manage tool positioning, enabling independent interaction with the workpiece and seamless transitions between active and inactive tools for optimal robotic functionality. In certain embodiments, the tool changer may be powered by the robot and/or separately powered by a motor of the tool changer, such as a direct drive motor.

In certain embodiments, a robotic system with automatic tool changing may include the disk-type tool changer. This system may employ a fixed base, a motor-driven turret with multiple tools, and the controller managing tool positioning, workpiece interaction, and smooth transitions between active and inactive tools. The robotic system may include the crown-type tool changer including a belt drive unit, a motor-driven turret, multiple tools, and a controller for tool movements, independent workpiece interactions, and transitions between tools.

In certain embodiments, a method for integrated automatic tool changing in a robotic system may include providing a robot and a tool changer device, then utilizing a controller to manage tool positioning, workpiece interaction, and transitions between active and inactive tools. The tool changer device may include a motor and a turret with a turret axis. The turret may be rotatably coupled to the motor, such that the turret may be rotatable about the turret axis. A plurality of tools may be arranged on the turret. and include a controller in communication with the motor, the plurality of tools, and the robot. The controller may be configured for operating the motor to selectively move one of the plurality of tools arranged on the turret to an active position by rotating the turret with the motor.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a block diagram illustrating a tool changer device, according to an embodiment of the present disclosure.

FIG. 2 is a block diagram further illustrating a disc-type tool changer device, according to an embodiment of the present disclosure.

FIG. 3 is a block diagram illustrating a crown-type tool changer device, according to an embodiment of the present disclosure.

FIG. 4 is a block diagram further illustrating a belt drive unit for the tool changer device, according to an embodiment of the present disclosure.

FIG. 5 is an isometric perspective view of a disc-type tool changer device showing various tool positions. according to an embodiment of the present disclosure.

FIG. 6 is front perspective view of a disc-type tool changer device showing various tools installed in tool positions, according to an embodiment of the present disclosure.

FIG. 7. is a drawing showing a disk-type tool changer device and a crown-type tool changer device, each resting on a fixed base station and ready for coupling to a robot, according to an embodiment of the present disclosure.

FIG. 8 is front perspective view of a crown-type tool changer device, according to an embodiment of the present disclosure.

FIG. 9 is front perspective view of a crown-type tool changer device with various tool positions attached to an end-effector of a robot according to an embodiment disclosure.

FIG. 10 is a perspective view of a crown-type tool changer device indexing a tool position to an active position, according to an embodiment of the present disclosure

FIG. 11 is a perspective view of a crown-type tool changer device with a plurality of attached tools indexing a tool to an active position, according to an embodiment of the present disclosure.

FIG. 12 is a perspective view of a crown-type tool changer device with a plurality of attached tools attached to a robot and approaching a workpiece, according to an embodiment of the present disclosure.

FIG. 13 is a flowchart illustrating a method for integrated automatic tool changing in a robotic system, according to an embodiment of the present disclosure.

FIGS. 14A & 14B provide a flowchart illustrating a method for using a disc-type tool changer device, according to an embodiment of the present disclosure.

FIGS. 15A & 15B provide a flowchart illustrating a method for using a crown-type tool changer device, according to an embodiments of the present disclosure.

FIG. 16 is an exploded view of a disc-type tool changer device according to an embodiment of the present disclosure.

FIG. 17 is an exploded view of a crown-type tool changer device according to an embodiment of the present disclosure.

### DETAILED DESCRIPTION

The following description of technology is merely exemplary in nature of the subject matter, manufacture, and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps may be different in various embodiments, including where certain steps may be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

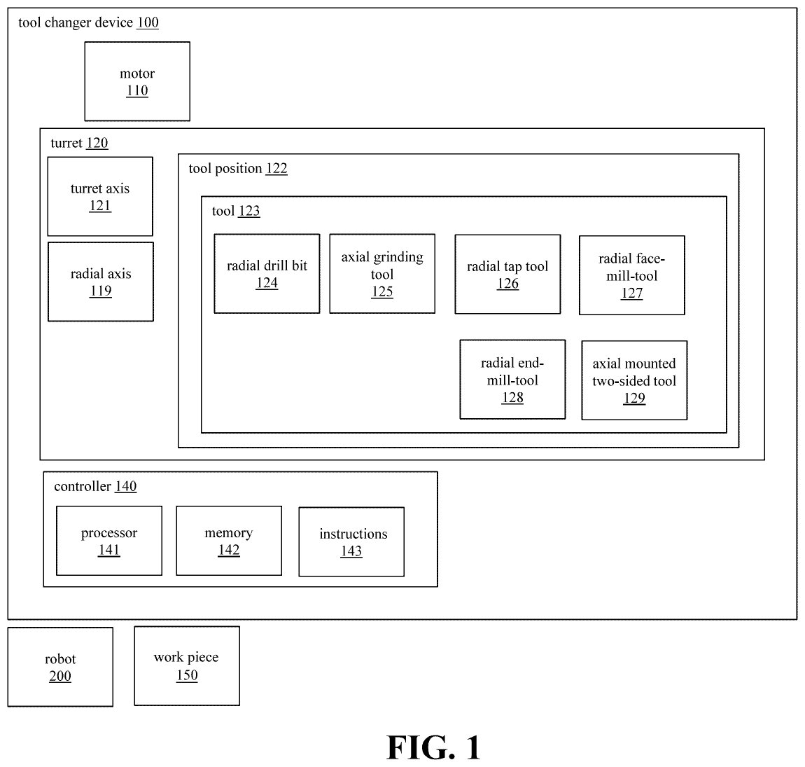

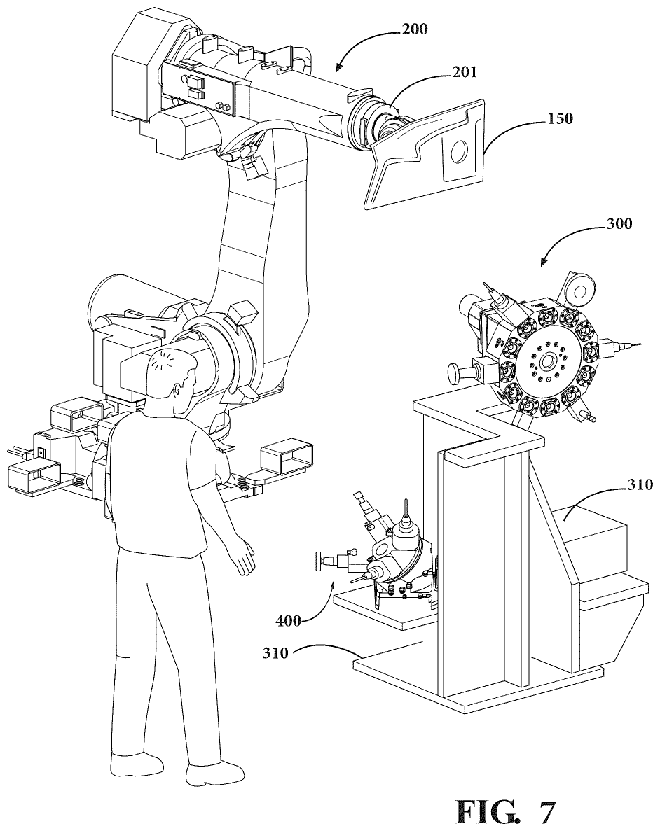

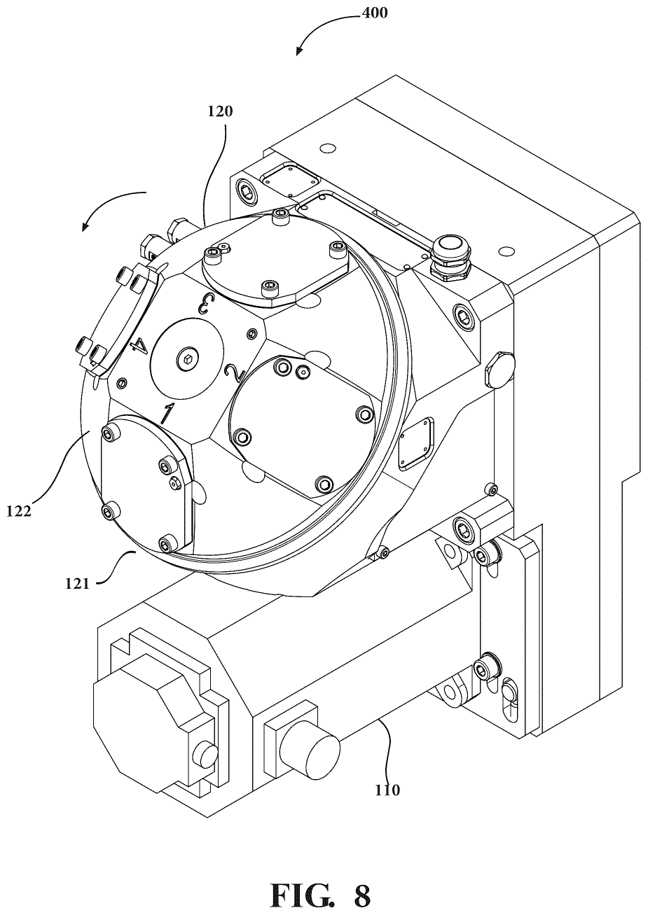

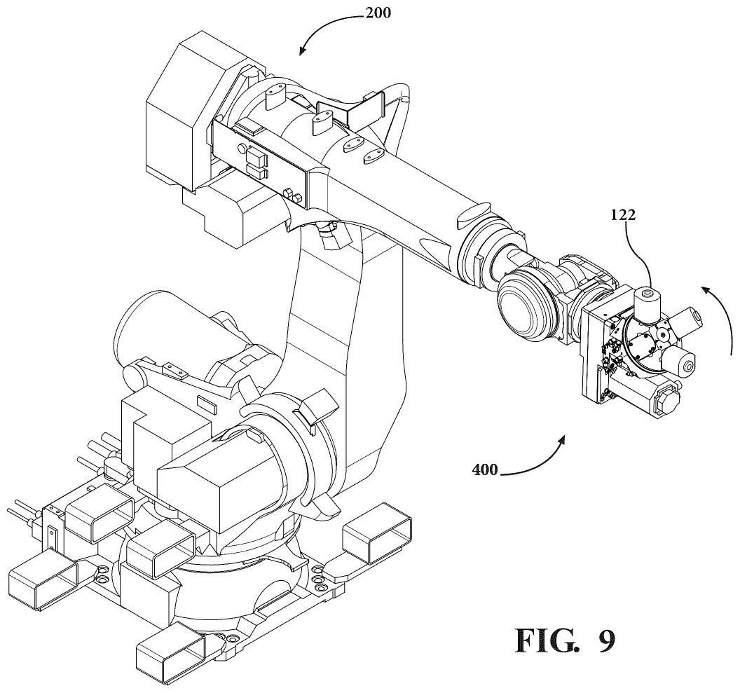

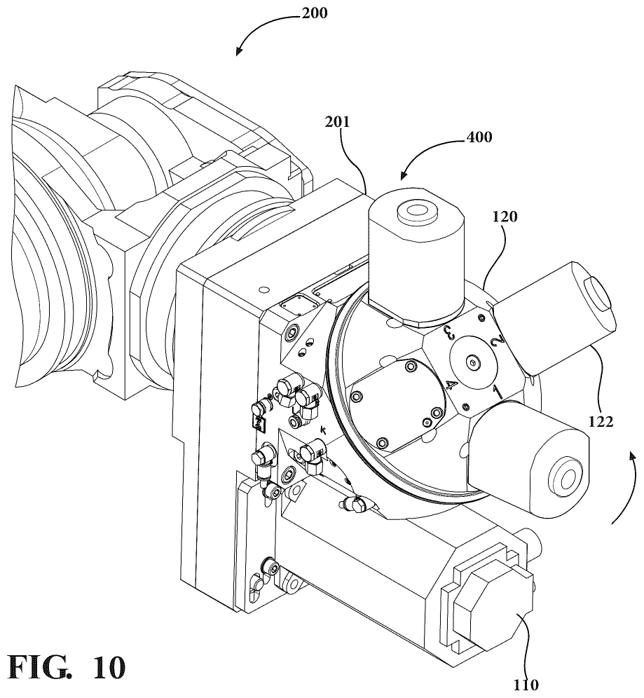

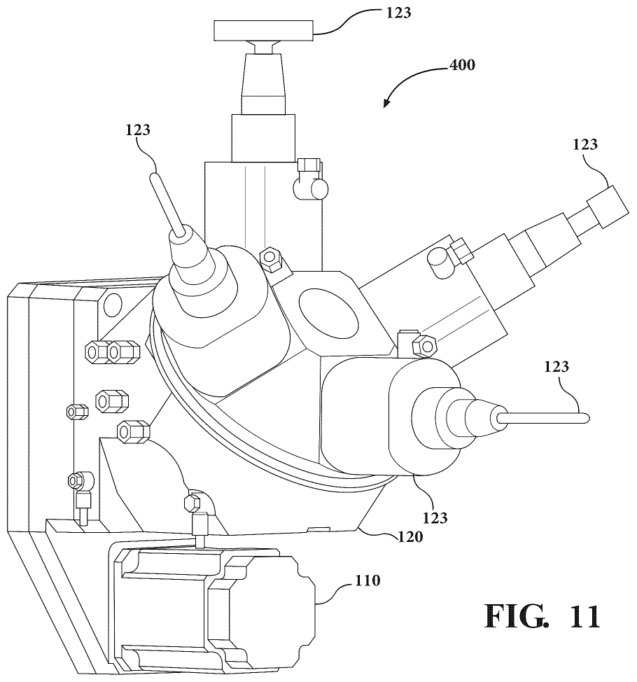

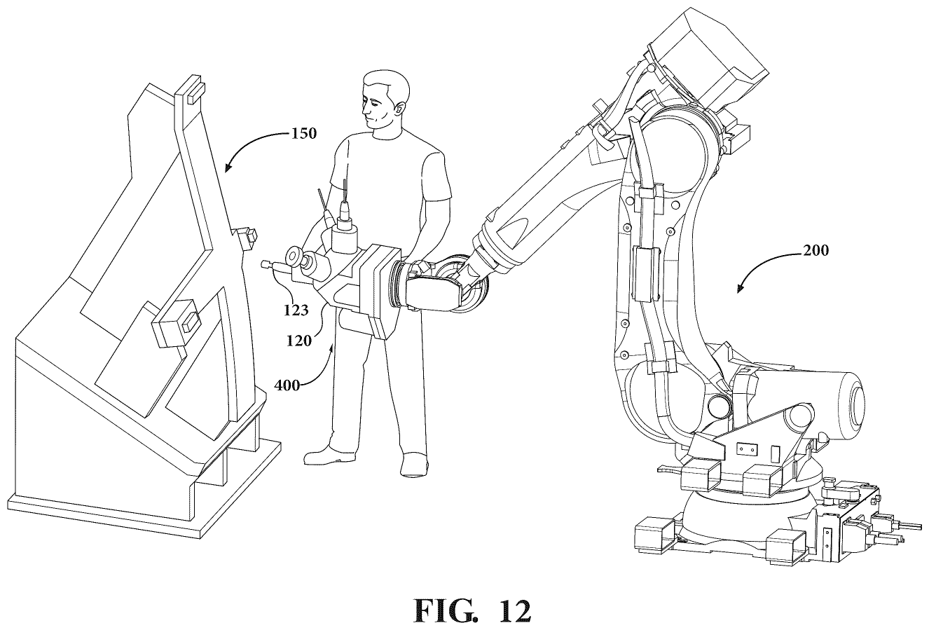

As shown in FIGS. 1-12, the present technology improves on a robot tool changer device with turret rotation and tool selection capabilities.

FIG. 1 is a block diagram illustrating a tool changer device 100, according to some embodiments of the present disclosure. The tool changer device 100 may be configured as a self-powered stand-alone device and also be configured to couple with a robot 200. A turret 120 may be rotatable relative to the robot 200 about a turret axis 121. The turret 120 may include one or more tool positions 122 arranged thereon. In certain embodiments, a motor 110 as a component of the tool changer device 100 and/or the robot may be configured to rotate the turret 120. A controller 140 including one or more of a processor 141, a memory 142, and executable instructions 143 may be in communication with the turret 120, the tool position 122, the motor 110, and the robot 200. The controller 140 may be operable to selectively move the tool position 122 to an active position by rotating the turret 120. In certain embodiments, the one or more tool positions 122 of the tool changer device 100 may be configured to receive one or more of a radial drill bit 124, an axial grinding tool 125, a radial tap tool 126, a radial face-mill-tool 127, a radial end-mill-tool 128, an axial mounted two-sided tool 129, and combinations thereof. However, as would be apparent to someone of ordinary skill in the art, the tool 123 may include any appropriately desired tool for engaging a workpiece 150.

In certain embodiments, the motor 110 may include an AC servo motor and/or a direct drive motor configured to provide controlled speed and torque. The motor 110 may be configured to operate the active position of the various tool positions 122. In this way, the motor can power a tool coupled to the active tool position 122 and can power the tool independent of the capabilities of the robot 200 to which the tool changer device 100 is coupled thereto. For example, the motor 100 can be configured to provide speed and torque well beyond the capabilities of robot motors used to operate end effectors and/or motors of the robot used to operate various axes of a multi-axis robot 200. Certain embodiments of the motor 100, including where the motor 110 is configured as an AC servo motor or a direct drive motor, allow operation of the tool 123 in the active tool position 122 in a high-speed capacity suitable for milling various metals and metal alloys, including various cast components.

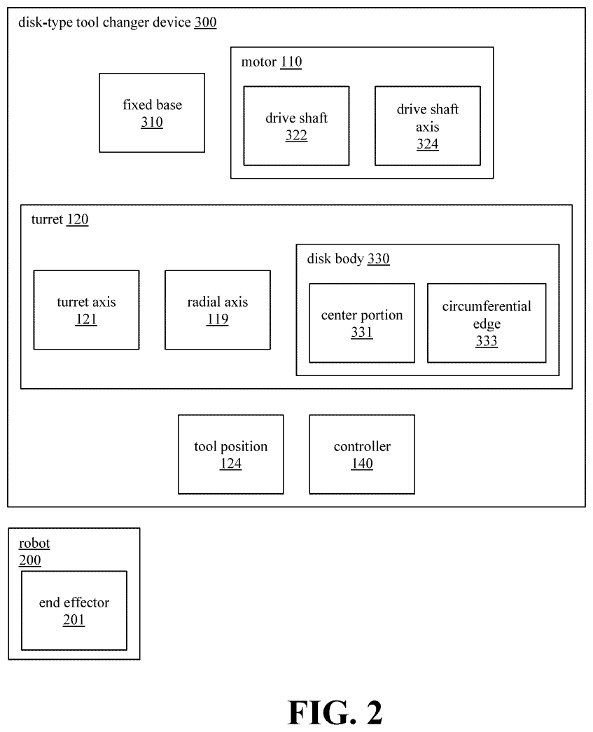

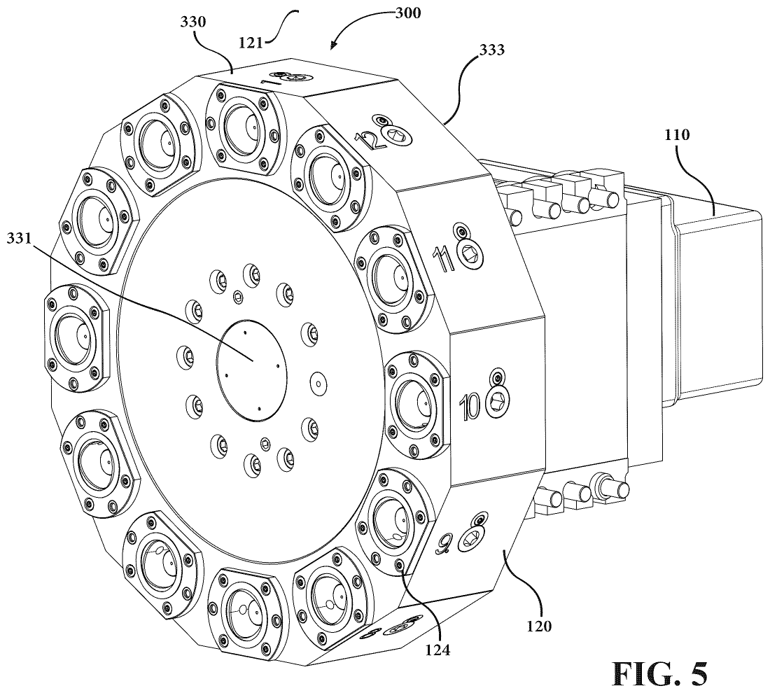

The turret 120 may be rotatably coupled to the motor 110. As shown FIGS. 2 and 10-12 the tool changer device 100 may include a disk-type tool changer device 300 configured to be coupled to the robot 200. Alternatively, the tool changer device 100 may include a crown-type tool changer device 400 configured to be coupled to the robot 200. In the disk-type tool changer device 300 configuration, and as shown in FIG. 5, the turret 120 may include a body having a center portion 331 and a circumferential edge 333, with one or more tool positions 122 arranged on the circumferential edge 333.

The processor 141 and memory 142 of the controller may store the executable instructions 143 for operating the motor 110. The instructions 143 may be tangible, non-transitory, and processor-readable and may be stored on the memory 142. The instructions 143 may be configured for operating the motor 110 by the controller 140, operating the active position for the one or more tool positions 122 and hence operating the tool associated therewith, communicating with the robot 200, and/or for communicating with other aspects of the system or work area.

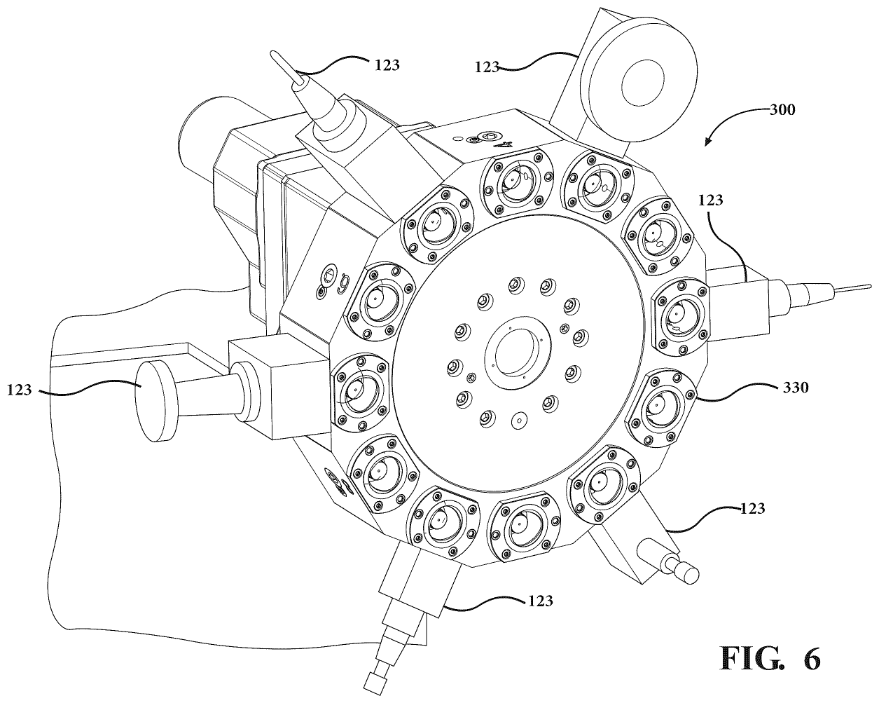

The controller 140 may be in wired or wireless communication with the motor 110, the various tool positions 122, the active tool position 122 and any tools associated therewith, and the robot 200. The robot 200 may include a multi-axis robotic arm. However, the robot 200 may include any appropriately desired robot 200 including an interface for receiving the tool changer device 100. The controller 140 may be configured for operating the motor 110. The turret 120 may include the turret axis 121, such that the turret 120 may be rotatably coupled to the motor 110 and spin about the turret axis 121, such as shown by the arrows within FIGS. 6 and 8-11.

In certain embodiments, the controller 140 may be configured to selectively move the tool position 122 and associated tool 123 arranged on the turret 120 to an active position by rotating the turret 120 with the motor 110. The motor 110 may be a component of the tool changer device 100 or the robot 200. The controller 140 may hold the tool 123 arranged on the turret 120 at the active position for an independent interaction by the tool 123 with a workpiece. The controller 140 may also be configured to selectively move the tool 123 to an inactive position and move another tool 123 arranged on the turret 120 to the active position by rotating the turret 120 with the motor 110. The controller 140 may be further configured to selectively hold a tool 123 arranged on the turret 120 in the active position during an independent interaction by another tool 123 with a workpiece 150.

The controller 140 may be configured to selectively hold a tool 123 arranged on the turret 120 in the active position. The crown-type tool changer device 400 may permit the robot 200 to move a tool 123 in the active position adjacent to the workpiece 150 for an independent interaction. The crown-type tool changer device 400 may cause a tool 123 to independently interact with the workpiece 150. The crown-type tool changer device 400 may permit the robot 200 to move another tool 123 in the active position away from the workpiece 150 following the independent interaction.

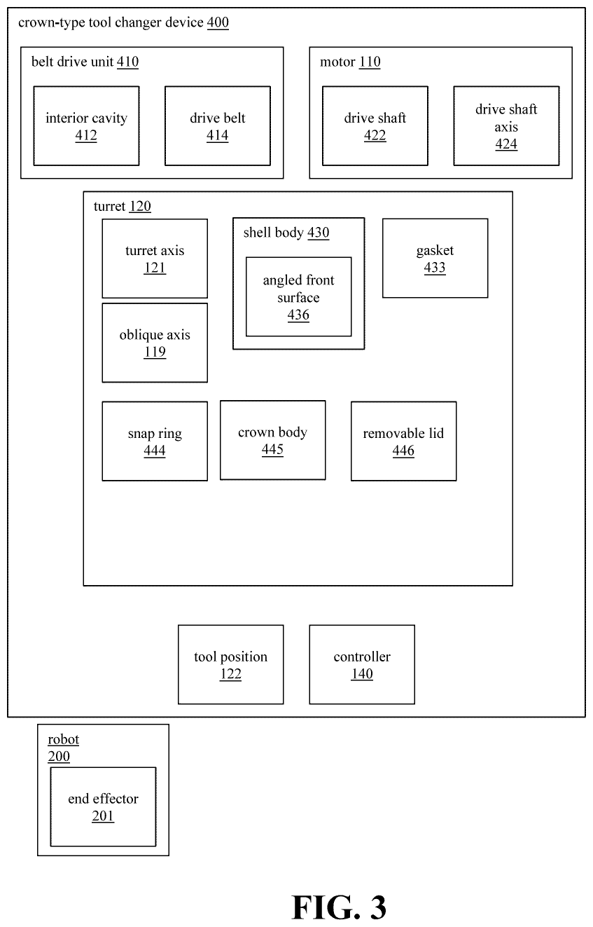

In certain embodiments, where the tool changer device 100 is a disk-type tool changer device 300, such as shown in FIGS. 2 and 5-6 and as described below, the tool changer device 100 may be stored on a fixed base 310 on a floor surface adjacent the robot 200, for example. Where the tool changer device 100 is a crown-type tool changer device 400, such as shown in FIGS. 3, and 5-9 (described below,) the tool changer device 100 may be similarly be stored on the fixed base 310 adjacent the robot 200. In this way, the robot 200 can move to the fixed base 310, where either the disk-type tool changer device 300 or the crown-type tool changer device 400 is selected and coupled to the robot 200.

FIG. 2 shows a block diagram that describes a disk-type tool changer device 300, with embodiments also shown in FIGS. 5-6. The disk-type tool changer device 300 may include a motor 110, a turret 120, and a tool 123 arranged on the turret 120. The disk-type tool changer device 300 may also include the controller 140 in communication with the motor 110, the tool 123, and the robot 200, such as described above. The controller 140 may be configured for operating the motor 110. Referring still to FIG. 2, the motor 110 may include a drive shaft 322 and a drive shaft axis 324. The drive shaft 322 may be rotatable about the drive shaft axis 324. The turret 120 may include the turret axis 121 and the radial axis 119. The turret 120 may be rotatably coupled to the drive shaft 322 of the motor 110. The controller 140 may be configured to selectively move the tool 123 at one of the tool positions 122 arranged on the turret 120 to an active position by rotating the turret 120 with the motor 110.

The disk-type tool changer device 300 may permit the robot 200 to move the tool 123 in the active position adjacent a workpiece 150 to perform an operation, such as milling. In certain embodiments, the disk-type tool changer device 300 causes the tool 123 to independently interact with the workpiece. The disk-type tool changer device 300 also permits the robot 200 to move the tool 123 in the active position away from the workpiece 150 following an independent interaction.

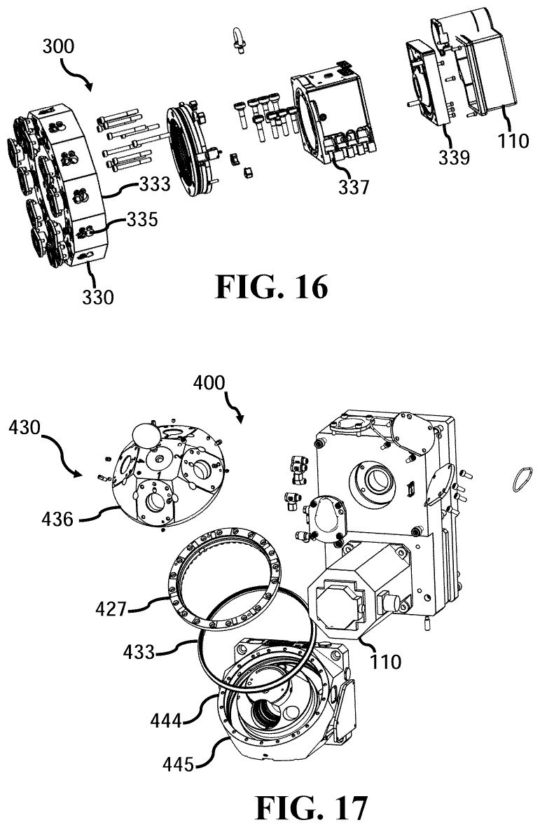

The disk-type tool changer device 300 and turret 120 may include a disk body 330. The disk body 330 may include a center portion 331 and a circumferential edge 333. The disk body 330 may be attached to the drive shaft 322 of the motor 110. One or more tools 123 may be coupled to one or more tool positions along the circumferential edge 333 of the disk body 330. The tool positions 122 may be spaced substantially equally apart along the circumferential edge 333 of the disk body 330. In certain embodiments, such as shown in the exploded view of FIG. 16, the disk-type tool changer device 300 may further include a clamping unit 335, a housing 337, and a bearing plate 339 between the motor 110 and the housing 337.

In certain embodiments, the drive shaft axis 324 and the turret axis 121 may be coextensive. A tool 123 may also be oriented on a radial axis 119 radiating outwardly from the drive shaft axis 324 and the turret axis 121. The disk body 330 of the turret 120 may further be laterally spaced apart from the fixed base 310. The robot 200 may also include a multi-axis robotic arm, in particular embodiments, and the workpiece may be mounted to the multi-axis robotic arm. The robot 200 may also have an end effector 201 that accepts the tool changer device 100 or the tool changer device 100 may replace an end effector 201 of the robot 200.

FIGS. 3-4 and 8 depict aspects of a crown-type tool changer device 400, according to an embodiment of the present disclosure. The crown-type tool changer device 400 may include a motor 110, a turret 120, and a tool position 122 arranged on the turret 120. The crown-type tool changer device 400 may also include a belt drive unit 410 coupled to the motor 110 and mounted to the robot 200. The crown-type tool changer device 400 may also include the controller 140 in communication with the motor 110, the tool position 122, and the robot 200. As described above, the controller 140 may be configured for operating the motor 110.

The belt drive unit 410 may include an interior cavity 412. A drive belt 414 may be contained within the interior cavity 412. The motor 110 may include a drive shaft 422 and a drive shaft axis 424. The drive shaft 422 may be rotatable about the drive shaft axis 424. In certain embodiments, the motor 110 may be coupled to the belt drive unit 410 and the drive shaft 422 may be operatively coupled to the drive belt 414.

In certain embodiments, such as with the crown-type tool changer device 400, as shown in FIG. 3, the turret 120 may include a turret axis 121. The turret 120 may be rotatably coupled to the motor 110. The turret may be rotatable about the turret axis 121, and may mount to the belt drive unit 410. The crown-type tool changer device 400 may permit the robot 200 to move the tool 123 to one of the tool positions 122 to the active position to operate on the workpiece 150. The crown-type tool changer device 400 may cause the tool 123 to independently interact with the workpiece 150.

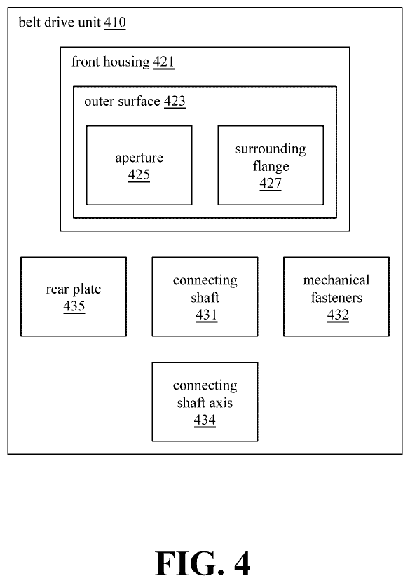

As further shown in FIG. 4, the belt drive unit 410 may include a front housing 421, a rear plate 435, a connecting shaft 431, a connecting shaft axis, and a mechanical fastener 432. The mechanical fasteners 432 may removably attach the front housing 421 to the rear plate 435. The front housing 421 and the rear plate 435 may together define the interior cavity 412. The front housing 421 may include an outer surface 423. The outer surface 423 may include an aperture 425 and a surrounding flange 427. The connecting shaft 431 may be disposed through the aperture 425 and operatively coupled to the drive belt 414, as depicted in FIG. 3, and the connecting shaft 431 oriented on the connecting shaft axis 434.

Referring again to FIG. 3 and shown in the exploded view of FIG. 17, the turret 120 of the crown-type tool changer device 400 may include a shell body 430 comprising an angled front surface 436, a gasket 433, a snap ring 444, a crown body 445, a oblique axis 119, and a removable lid 446. The shell body 430 may be mounted on the surrounding flange 427 of the belt drive unit 410. The gasket 433 may be disposed between the shell body 430 and the snap ring 444, and the snap ring 444 may be disposed between the gasket 433 and the crown body 445.

The shell body 430 may also include the angled front surface 436 to which the crown body 445 may be rotatably mounted. The turret axis 121 of the turret 120 may be oriented at an angle relative to the connecting shaft axis 434 of the connecting shaft 431 of the belt drive unit 410. The drive shaft axis 424 may be oriented substantially parallel with the connecting shaft axis 434. A tool 123 may be oriented on one of a plurality of oblique axes radiating outwardly from a connecting shaft axis 434. A removable lid 446 may be removably attached with an additional fastener to the crown-type tool changer device 400 at a tool position 122 on where a tool 123 may be coupled.

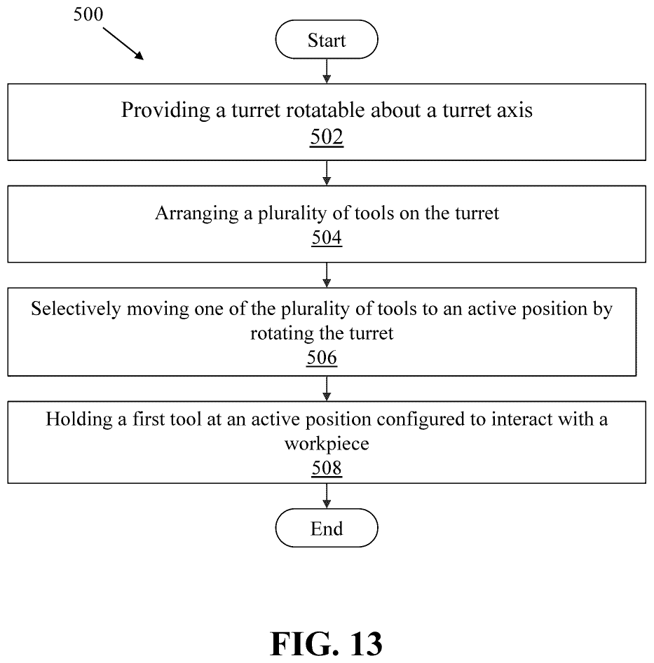

FIG. 13 shows a method 500 for integrated automatic tool changing in a robotic system, such as a tool changer device 100, as described above. In a step 502, a turret 120 rotatable about a turret axis 121 is provided. Then, in a step 504, a tool 123 may be arranged on the turret 120. In a step 506, a tool 123 may be moved to an active position by rotating the turret 120, and in a step 508, the tool 123 may be held at an active position configured to interact with a workpiece 150.

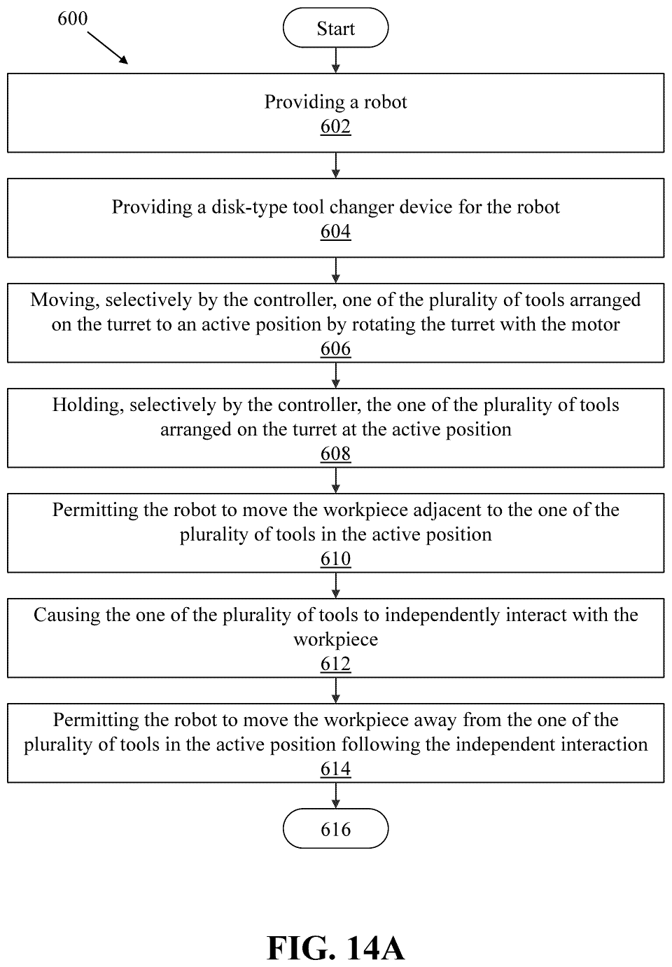

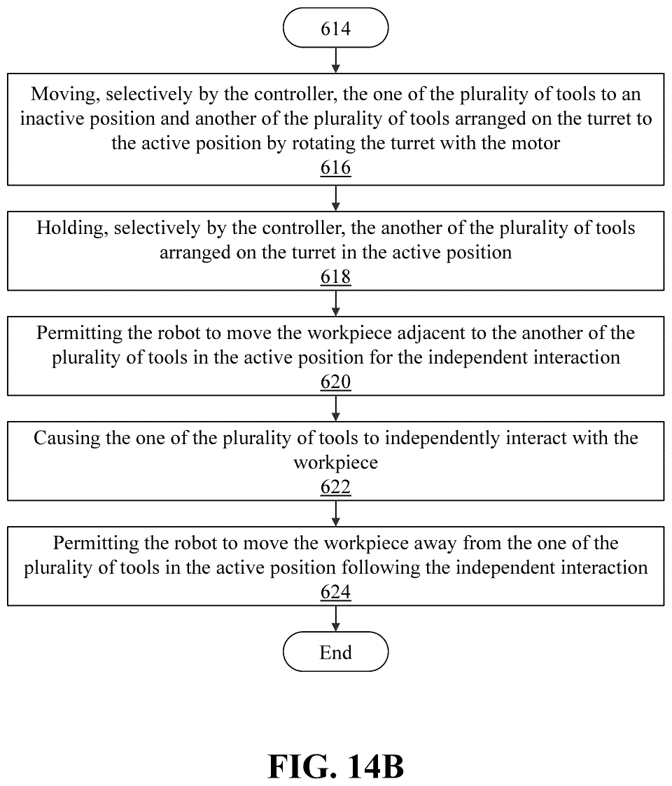

FIGS. 14A to 14B are a flowchart that describes a method 600, according to some embodiments of the present disclosure. At a step 602, the method 600 may include providing a robot, for example, as described hereinabove. At a step 604, the method 600 may include providing a tool changer device 100 for the robot 200. At a step 606, the method 600 may include moving, selectively by the controller 140, a tool 123 arranged on the turret 120 to an active position by rotating the turret 120 with the motor. At a step 608, the method 600 may include holding, selectively by the controller 140, the tool 123 arranged on the turret 120 at the active position for an independent interaction by the tool with a workpiece 150.

At a step 610, the method 600 may include moving, selectively by the controller 140, the tool 123 to an inactive position and another tool 123 arranged on the turret 120 to the active position by rotating the turret 120 with the motor 110. At a step 612, the method 600 may include holding, selectively by the controller 140, a tool 123 arranged on the turret 120 in the active position or the independent interaction the tool 123 with the workpiece 150. A step 614, the method may include Permitting the robot to move the workpiece away from the one of the plurality of tools in the active position following the independent interaction.

In certain embodiments, the method 600 may further include moving, selectively by the controller 140, the tool 123 to an inactive position and another tool 123 arranged on the turret 210 to the active position by rotating the turret 120 with the motor 110 at a step 616 and holding, selectively by the controller 140, another tool 123 arranged on the turret 120 in the active position in a step 618. In a step 620, the method may include permitting the robot 200 to move the workpiece 150 adjacent to the tool 123 in the active position for the independent interaction. In a step 622, the method may include causing the tool 123 to independently interact with the workpiece, and in the step 624 the method may include permitting the robot 200 to move the workpiece 150 away from the tool 123 in the active position following the independent interaction.

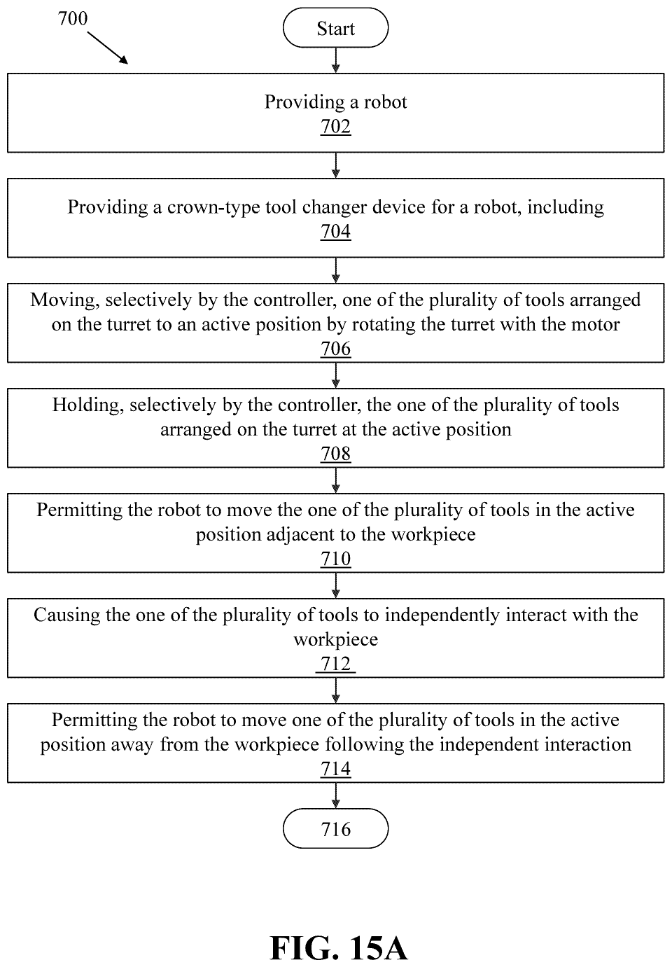

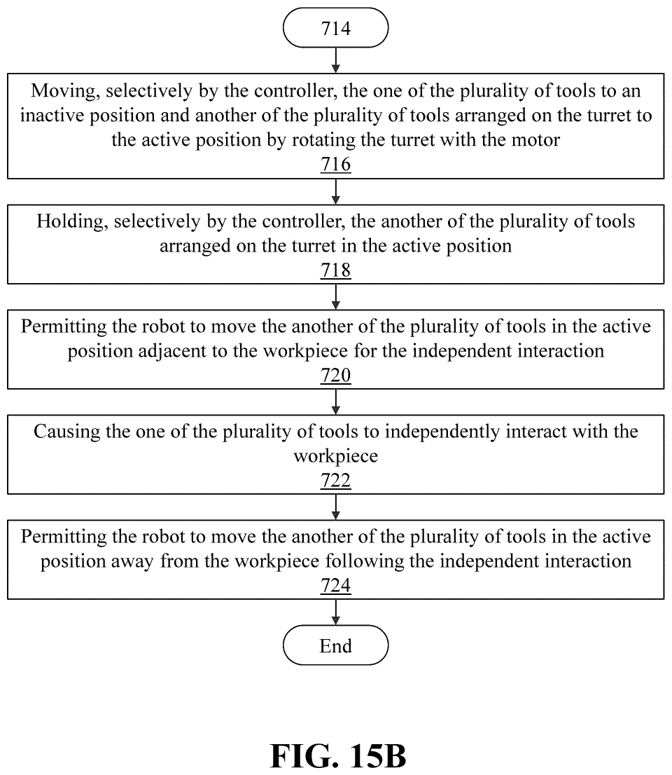

FIGS. 15A to 15B are flowcharts that describe another method 700, according to an embodiment of the present disclosure. At a step 702, the method 700 may include providing a robot 200. At a step 704, the method 700 may include providing a crown-type tool changer device for the robot 200. At a step 706, the method 700 may include moving, selectively by the controller 140, a tool 123 arranged on the turret 120 to an active position by rotating the turret 120 with the motor. At a step 708, the method 700 may include holding, selectively by the controller 140, the tool 123 arranged on the turret 120 at the active position. At a step 710, the method 700 may include permitting the robot 200 to move the workpiece 150 adjacent to the tool 123 in the active position. At a step 712, the method may include causing the one of the plurality of tools to independently interact with the workpiece. At a step 714, the method 700 may include permitting the robot 200 to move the workpiece 150 away from the one of the plurality of tools in the active position following the independent interaction.

In certain embodiments, at a step 716, the method 700 may include moving, selectively by the controller 140, the tool 123 to an inactive position and another tool 123 arranged on the turret 120 to the active position by rotating the turret 120 with the motor 110. At a step 718, the method 700 may include holding, selectively by the controller 140, another tool 123 arranged on the turret 120 in the active position.

At a step 720, the method 700 may include permitting the robot 200 to move the workpiece 150 adjacent to a tool 123 in the active position for an independent interaction. Then, at a step 722, the method 700 may include causing a tool 123 to independently interact with the workpiece 150. At a step 724, the method 700 may include permitting the robot to move the workpiece away from the one of the plurality of tools in the active position following the independent interaction.

### EXAMPLES

Example embodiments of the present technology are provided with reference to the FIGS. 1-12 enclosed herewith.

Tool Changer Components: Example devices include a turret 120 powered by a motor 110 that may hold a tool 123, the turret 120 operable to rotate a position the tool 123. The devices may include a controller110 to manage tool 123 selection and interaction with a workpiece 150.

Tool Selection and Interaction: The controller 140 may enable a tool 123 to be moved into an active position for independent interaction with a workpiece 150. After the interaction, the tool 123 may be rotated in and out as needed.

Device Variation: There are different types of tool changer devices according to the examples shown in FIGS. 1-12, including (i) disk-type and (ii) crown-type. Both enable various tools to be selectively positioned, individually, for workpiece interaction.

System Functions: Example systems may further integrate with a robot 200, enabling automatic tool 123 changing. Example methods involve providing the robot 200 with a tool changer device 100, moving a tool 123 into position, enabling an interaction with the workpiece 150, and rotating to another tool 123 as required.

Overall, these devices, systems, and methods allow a robot 200 to efficiently change and utilize a tool 123 for different tasks without requiring manual intervention. The robotic end of arm turret with an integrated automatic tool changer of the present disclosure can have a chip-to-chip cycle time of less than five seconds, reducing the cycle time and reducing costs. The devices, systems, and methods of the present disclosure also carry up to eight work tools, in particular embodiments.

The devices, systems, and methods of the present disclosure have also been found to be surprisingly useful with electric vehicle investments in manufacture of “Giga Press” cast components (e.g., used by Tesla, GM, Ford, etc). The Giga Press program involves a series of aluminum die casting machines manufactured for Tesla. The process generally involves shots of molten aluminum that are injected into a cold-chamber casting mold with a velocity of 10 meters per second. The cycle time may be very low at between 80 to 90 seconds, allowing for an initial output rate of about 40 to 45 completed castings per hour. This makes cycle times with post-casting processes all the more critical. These castings then need to be milled, where dedicated and specialized CNC machines may be replaced with multi-axis robots having the tool changer devices of the present disclosure coupled thereto. The tool changer devices can employ a motor having the speed and torque necessary for effective milling of cast parts.

The devices, systems, and methods of the present disclosure have been found to be particularly suitable for post-casting processing of workpieces including: (i) metal, plastic, and wood machining; (ii) deburring of metal parts; (iii) de-flashing of cast metal or plastic parts; (iv) polishing or bright finishing of metal parts; and (v) various metal cutting applications for automobile, aerospace, and marine applications.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions, and methods can be made within the scope of the present technology, with substantially similar results.

What is claimed is:

1. A tool changer device for a robot, comprising:
a turret configured to be rotatable relative to the robot about a turret axis, the turret including a plurality of tool positions arranged thereon;
a motor configured to rotate the turret; and
a controller configured to be in communication with the turret, the plurality of tool positions, the motor, and the robot, the controller operable to:
selectively move one of tool positions to an active position by rotating the turret.

2. The tool changer device of claim 1, further comprising a robot coupled to the tool changer device.

3. The tool changer device of claim 1, wherein the motor includes an AC servo motor.

4. The tool changer device of claim 1, wherein the motor includes a direct drive motor configured to provide controlled speed and torque.

5. The tool changer device of claim 1, wherein the turret is rotatably coupled to the motor through a drive belt system.

6. The tool changer device of claim 1, wherein the tool changer device is one of a disk-type tool changer device mounted to a floor surface adjacent the robot, and a crown-type turret tool changer device mounted as an end effector to the robot.

7. The tool changer device of claim 1, wherein the plurality of tool positions includes a tool selected from a group consisting of a radial drill bit, an axial grinding tool, a radial tap tool, a radial face-mill-tool, a radial end-mill-tool, an axial mounted two-sided tool, and combinations thereof.

8. The tool changer device of claim 1, wherein the turret comprises a disk body having a center portion and a circumferential edge, with the plurality of tool positions arranged on the circumferential edge.

9. The tool changer device of claim 1, wherein the controller includes a processor and memory storing instructions for operating the motor.

10. A method for integrated automatic tool changing in a robotic system, comprising:
providing a turret rotatable about a turret axis;
arranging a plurality of tools on the turret;
selectively moving one of the plurality of tools to an active position by rotating the turret; and
holding a first tool at an active position configured to interact with a workpiece.

11. The method of claim 10, further comprising:
moving the first tool to an inactive position;
moving a second tool to the active position; and
holding the second tool in the active position for interaction with the workpiece.

12. The method of claim 10, further comprising coupling the turret to a robot.

13. The method of claim 10, wherein rotating the turret comprises driving the turret with an AC servo motor.

14. The method of claim 10, wherein rotating the turret comprises using a direct drive motor system with controlled speed and torque.

15. The method of claim 10, wherein rotating the turret comprises driving the turret through a belt drive system.

16. The method of claim 10, wherein providing the turret comprises providing one of a disk-type tool changer mounted to a floor surface, and a crown-type turret tool changer mounted as an end effector.

17. The method of claim 10, wherein arranging the plurality of tools comprises arranging at least one of a radial drill bit, an axial grinding tool, a radial tap tool, a radial face-mill-tool, a radial end-mill-tool, and an axial mounted two-sided tool.

18. The method of claim 10, wherein providing the turret comprises providing a disk body having a center portion and a circumferential edge with the plurality of tools removably attached to the circumferential edge.

19. The method of claim 10, further comprising controlling a rotation of the turret using a controller with stored instructions.

20. The method of claim 10, wherein arranging the plurality of tools comprises orienting each tool on one of a plurality of radial axes radiating outwardly from the turret axis.
